(19) United States
(12) Patent Application Publication
(10) Pub. No.: US 2026/0220598 A1
(43) Pub. Date: Jul. 30, 2026

(54) SCHEMATIC-BASED COMPREHENSIVE PART LIST GENERATION LEVERAGING GENERATIVE ARTIFICIAL INTELLIGENCE

(71) Applicant: Rockwell Automation Technologies, Inc., Mayfield Heights, OH (US)

(72) Inventors: Brian C. Frank, Cedarburg, WI (US); Mark R. Haas, Hudson, OH (US); Hailey M. Zawadzki, Colgate, WI (US); Steven R. Gorecki, Slinger, WI (US)

(21) Appl. No.: 19/038,971

(22) Filed: Jan. 28, 2025

(51) Int. Cl. G06Q 10/0875

(52) U.S. Cl. CPC G06Q 10/0875

(57) ABSTRACT

The disclosure describes an industrial resource service that leverages a generative artificial intelligence (GAI) model to facilitate the creation of industrial part-number lists based on schematics. Upon obtaining a schematic from a user, the industrial resource service generates one or more resource prompts tasking the GAI model to identify specific physical components within the schematic. The industrial resource service then builds the list of part numbers by mapping the identified physical components to part-numbers. The industrial resource service then provides the list of part numbers to a requesting user.

### BACKGROUND

Before building an industrial system, engineers typically create a functional schematic, such as a piping and instrumentation diagram (P&ID), to define the system’s operational requirements. Once the schematic is complete, specific industrial components are selected to meet these requirements. However, with the extensive range of components offered by various manufacturers, manually identifying the most appropriate choices can be both complex and inefficient.

Selecting components from a schematic often involves navigating extensive industrial documentation (e.g., product specifications, safety and regulatory guidelines, customer-specific standards), and weighing multiple performance considerations. This manual, labor-intensive process consumes significant engineering hours, increasing the likelihood of errors or suboptimal choices. Such inefficiencies can not only hinder the construction of a high-performing industrial system but also slow down delivery, strain engineering resources, and limit responsiveness to market demands.

### SUMMARY

The disclosure describes an industrial resource service that leverages a GAI model to generate part-number lists based on industrial schematic diagrams. A user on a user device may submit a schematic diagram to the industrial resource service with a request to generate the list of part numbers for building the industrial system. The industrial resource service first prompts the GAI model to identify specific physical components in the system corresponding to visual elements in the diagram, then maps the identified physical components to a list of part numbers. Users may thus quickly obtain lists of part numbers by simply submitting a schematic diagram to the industrial resource service, alleviating the above-described issues.

One example of a computer-implemented method performed according to some implementations includes obtaining, from a user device, a schematic diagram of an industrial system and a resource request for a list of part numbers to build the industrial system. The schematic diagram illustrates visual elements representing physical components in the industrial system and their associated functional specifications. The method further includes generating one or more resource prompts designed to elicit a response from a generative artificial intelligence (GAI) model. The one or more resource prompts task the GAI model with identifying specific physical components corresponding to the visual elements in at least a portion of the schematic diagram. Each of the one or more resource prompts includes at least a portion of the schematic diagram. The method may further include mapping the identified specific physical components to part numbers to generate the list of part numbers. The method may further include transmitting the list of part numbers to the user device for display.

In some implementations, the method further includes dividing the schematic diagram into a plurality of segments (e.g., grid segments). The one or more resource prompts may include multiple resource prompts according to some implementations. Each of the resource prompts tasks the GAI model with identifying the specific physical components in one of the segments.

In some implementations, mapping the identified specific physical components includes generating a consolidated prompt designed to elicit a response from the GAI model. The consolidated prompt tasks the GAI model with generating the list of parts based at least in part on a correlation between the identified specific physical components across the segments and the entire schematic diagram.

In some implementations, the consolidated prompt further includes customer-specific standards and tasks the GAI model with generating the list of part numbers based additionally on the customer-specific standards.

In some implementations, the method further includes generating a validation prompt designed to elicit a second response from the GAI model. The validation prompt tasks the GAI model with validating the list of components by cross-referencing the list of part numbers with the schematic diagram. The method may further include obtaining a validation response from the GAI model.

In some implementations, the validation response is a confirmation of accuracy for the list of resources. The method may further include transmitting an indication of the confirmation to the user device for display.

In some implementations, the validation response includes an identification of a potential issue with respect to the list of components. The method further includes initiating corrective action to address the potential issue.

In some implementations, the method further includes selecting the GAI model from multiple GAI models based on one or both of: an industry associated with a user submitting the resource request and a location of the user.

In some implementations, the method further includes transmitting, with the list of part numbers and to the user device, instructions to display a correlation between each part number in the list of part numbers and its associated visual element in the schematic.

In some implementations, the GAI model is trained on industrial documentation. This industrial documentation may include one or more of: historical industrial project data, industrial standards, and industrial product specifications.

These and other features and aspects of various examples may be understood in view of the following detailed discussion and accompanying drawings.

### BRIEF DESCRIPTION OF THE DRAWINGS

FIG. 1 illustrates an industrial automation environment in an implementation.

FIG. 2 illustrates an industrial resource service in an implementation.

FIG. 3 illustrates a resource list generation process in an implementation.

FIG. 4 illustrates an operational sequence in an implementation.

FIG. 5 illustrates a validation process in an implementation.

FIG. 6 illustrates another operational sequence in an implementation.

FIGS. 7A-7B illustrate user interfaces in an implementation.

FIG. 8 illustrates a computing system suitable for implementing the various operational environments, architectures, environments, processes, scenarios, sequences, and frameworks discussed below with respect to the other Figures.

### DETAILED DESCRIPTION

During the design phase of an industrial system, designers rely on functional design schematics to define the roles and relationships of various components within the system. One common example is a piping and instrumentation diagram (P&ID), which uses standardized symbols and annotations to represent components such as pumps, valves, and circuit breakers, while illustrating the connections and relationships between them, such as piping, flow paths, and control signals.

Constructing an industrial system based on such a schematic requires selecting specific components corresponding to the visual elements in the diagram. A customer may wish to procure these components from a particular industrial manufacturer (e.g., Rockwell Automation). The manufacturer may assist the customer by identifying suitable components and generating a list of part numbers (commonly referred to as a "Bill of Materials" or BOM). Alternatively, the customer may independently create the list. Once the list is generated, the customer can request a quote for purchasing the identified components.

Generating a comprehensive part number list can be challenging. For example, if a schematic specifies a motor with a 480V operating voltage and a 100-horsepower rating, the industrial operator selects a specific motor model from an industrial components catalog that meets these specifications and is suitable for the application. This process is labor-intensive, as schematics often contain numerous components, each with multiple available options. For instance, a schematic may include a pump, but an industrial catalog might offer dozens of pumps, only a subset of which meet the functional requirements defined in the schematic. The operator carefully analyzes product specifications to identify suitable options and, among those, balance price and performance to determine an appropriate choice.

In addition to being time-consuming, this process is prone to human error. For example, an operator may inadvertently select an inappropriate or suboptimal component or mistype a part number when compiling the list. Such errors can lead to inefficiencies, underperforming or inoperable systems, and increased costs.

The present disclosure describes an industrial resource service that leverages a generative artificial intelligence (GAI) model to generate a list of part numbers directly from the schematic, addressing the challenges described above. The industrial resource service allows users to upload, from a user device, a schematic along with a request for a list of part numbers for building the industrial system.

The industrial resource service prompts the GAI model to identify specific physical components corresponding to the visual elements in the schematic (e.g., the standardized symbols in a P&ID schematic). In some implementations, the industrial resource service may first divide the schematic into segments (e.g., grid segments) and then submit a prompt to the GAI model for each segment. For each prompt, the GAI model responds with the specific physical components identified within the corresponding segment. For example, a physical component identified by the GAI model may be a submersible pump with a voltage rating of 380 volts.

After obtaining the identified physical components from the GAI model, the industrial resource service maps these components to corresponding part numbers to create a comprehensive list of specific products needed to build the system. In this context, a “physical component” represents a general type of device (e.g., a “submersible pump”), while a “part number” refers to a specific, purchasable model of that device (e.g., a listed product from a manufacturer’s catalog). Thus, the mapping process transforms abstract component types into concrete, orderable items.

In some implementations, this mapping may involve generating and submitting a consolidated prompt to the GAI model that includes both the identified components and the full schematic. The GAI model then considers the functional requirements and interrelationships among the components to select appropriate part numbers from the available product catalog. Once the list of part numbers is compiled, the industrial resource service provides it to the user device for display, enabling the user to quickly identify and obtain the necessary components.

The present disclosure also describes a validation workflow for verifying a list of components against a schematic. This workflow can validate a part number list generated by the industrial resource service or one created independently by the customer. To perform the validation, the industrial resource service generates a prompt requesting validation from the GAI model, including both the part number list and the schematic. The GAI model evaluates the prompt and either approves the list or identifies potential issues, such as a visual element in the schematic lacking a corresponding part number. If approved, the industrial resource service transmits an approval indication to the user. If issues are identified, the industrial resource service initiates corrective actions, such as adding a missing part number to the list. This validation process provides an additional layer of error detection, enhancing efficiency and accuracy in building industrial systems.

The described technology significantly enhances the efficiency and quality of creating a list of part numbers based on a schematic. Instead of manually sifting through product specifications and building a list, which could take hours or days, users or industrial manufacturers can submit a schematic to the industrial resource service and receive a comprehensive list of part numbers (i.e., bill of materials) almost immediately. The list can identify each component needed, the quantity, and specifications for each component with no additional user intervention other than uploading the schematic. This automation drastically reduces the time and effort required, while also minimizing the likelihood of human error, such as selecting incompatible components or mis-entering part numbers. The technology reduces computing overhead for users by reducing the need for users to individually run local searches, simulations, or database queries. Furthermore, by breaking down schematics into segments (e.g., grid segments) and processing them separately in some implementations, the system facilitates more accurate results. This distributed approach enhances scalability, allowing the system to handle complex and large-scale schematics.

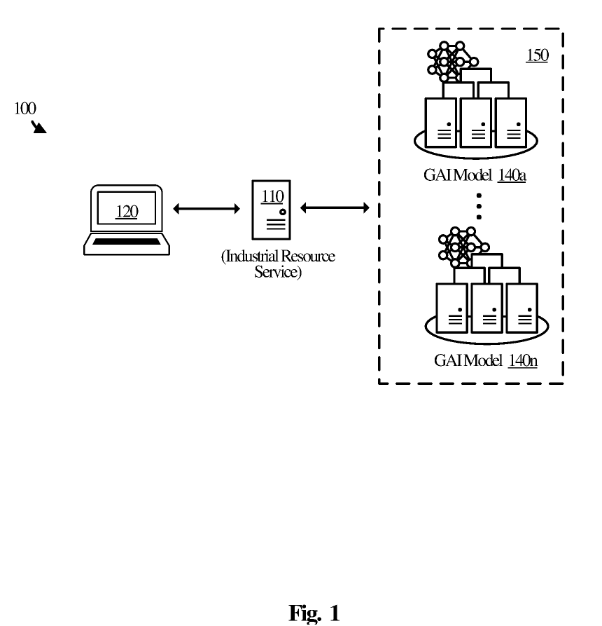

FIG. 1 illustrates industrial automation environment 100 in an implementation. Industrial automation environment 100 includes industrial resource service 110, user device 120, and model collection 150. While specific elements of industrial automation environment 100 are shown for ease of description, industrial automation environment 100 may include more or fewer of each described component as well as other components not described for simplicity.

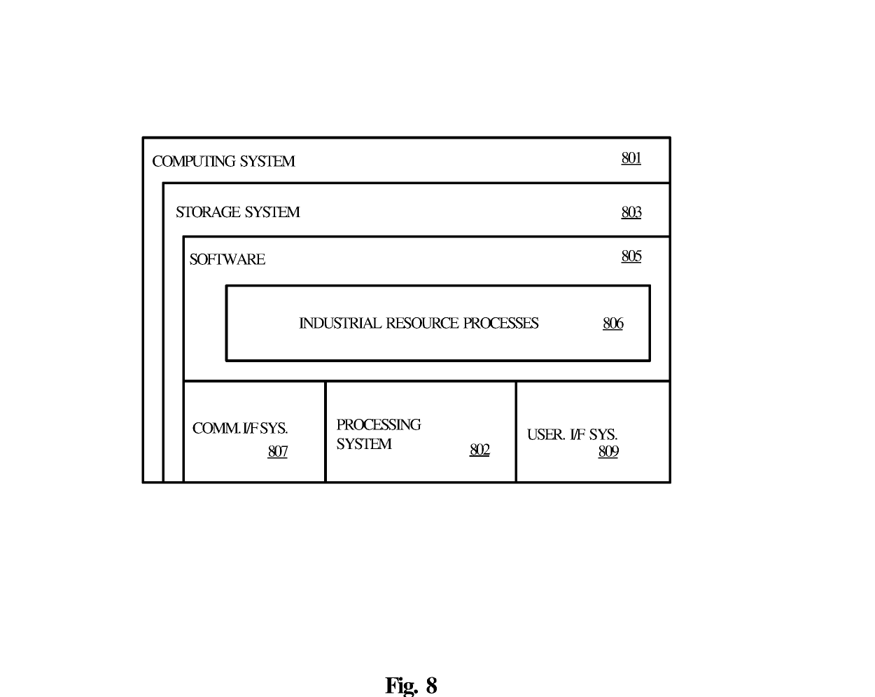

Industrial resource service 110 is representative of a service that creates and validates lists of part numbers (i.e., bill of materials) for users building industrial systems. Industrial resource service 110 may include software operating on one or more servers, which may be represented by computing system 801 of FIG. 8. In other implementations, industrial resource service 110 may be a cloud-based service. In some implementations, industrial resource service 110 may be integrated into various software tools, such as industrial design tools (e.g., Rockwell Advisor) to provide an integrated workflow. In other implementations, industrial resource service 110 may be a standalone service.

Industrial resource service 110 is configured to leverage GAI models 140a, 140n (collectively, GAI models 140), to generate the lists of part numbers based on schematics submitted from user device 120. These schematics may include various formats, including P&ID, industrial electrical schematics, motor control center layouts, or any other visual representation of an industrial system. The schematics may include visual representations of physical components (e.g., icons of pumps, valves, motors, transformers, etc.) and functional specifications for the components (e.g., text in proximity a pump icon setting forth a particular voltage rating and flow rate for the pump).

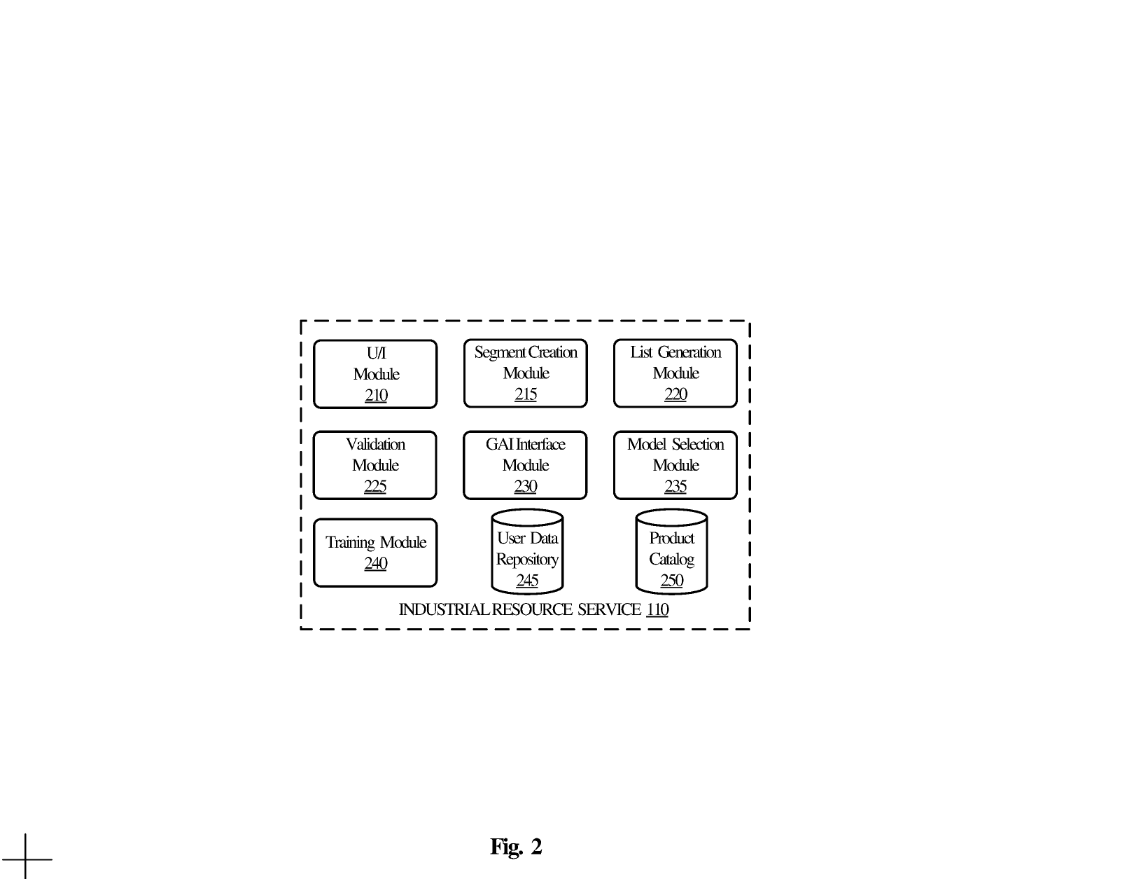

Industrial resource service 110 may first select a particular GAI model 140 from model collection 150. This selection may be based, for example, one or both of a relevant industry for the industrial system or a location for the industrial system – as different GAI models 140 from model collection 150 may be fine-tuned for specific locations and/or industries. Industrial resource service 110 generates one or more resource prompts for the selected GAI model 140. The one or more resource prompts task GAI model 140 with identifying specific physical components corresponding to the visual elements in the schematic. This process may involve dividing the schematic into grid segments and generating a resource prompt for each of the grid segments. While dividing the schematic into grid segments is discussed and depicted throughout this disclosure, any suitable segmenting or subdivisions may be used. For example, the schematic may be broken into segments by size, in various other shapes (e.g., blob, circular, triangular, or the like), with overlapping portions, or any other suitable subdivision may be used to divide the schematic and generate resource prompts for each segment. Further, the entire schematic may be submitted in some embodiments. For example, as computing power advances, larger schematics may be processed without subdivision. Industrial resource service 110 may also validate a list of part numbers against a schematic. These and other processes performed by industrial resource service 110 are discussed in greater detail in the discussion of FIG. 2 below.

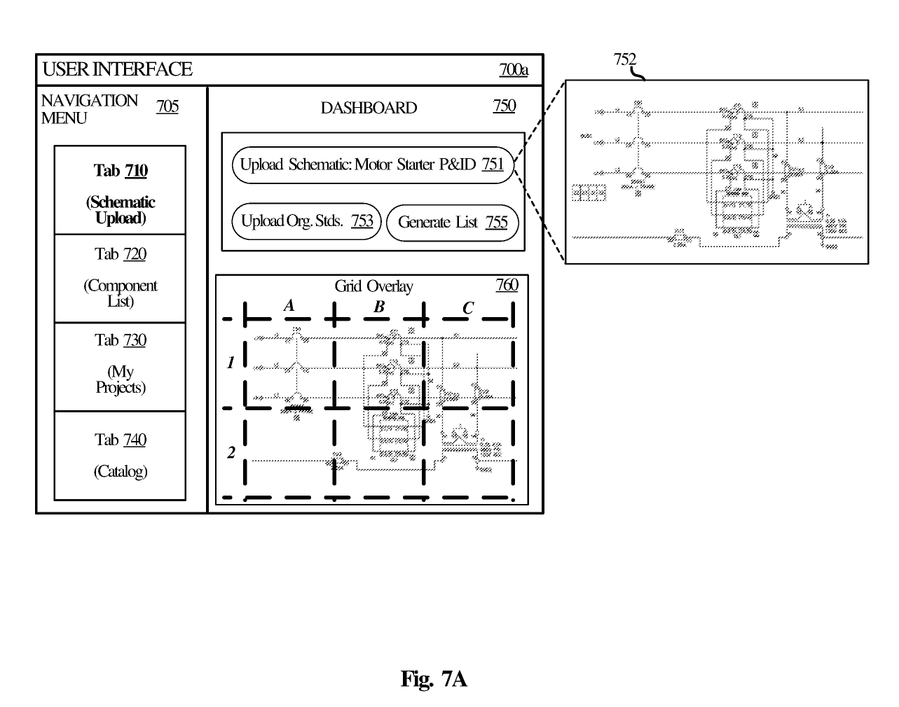

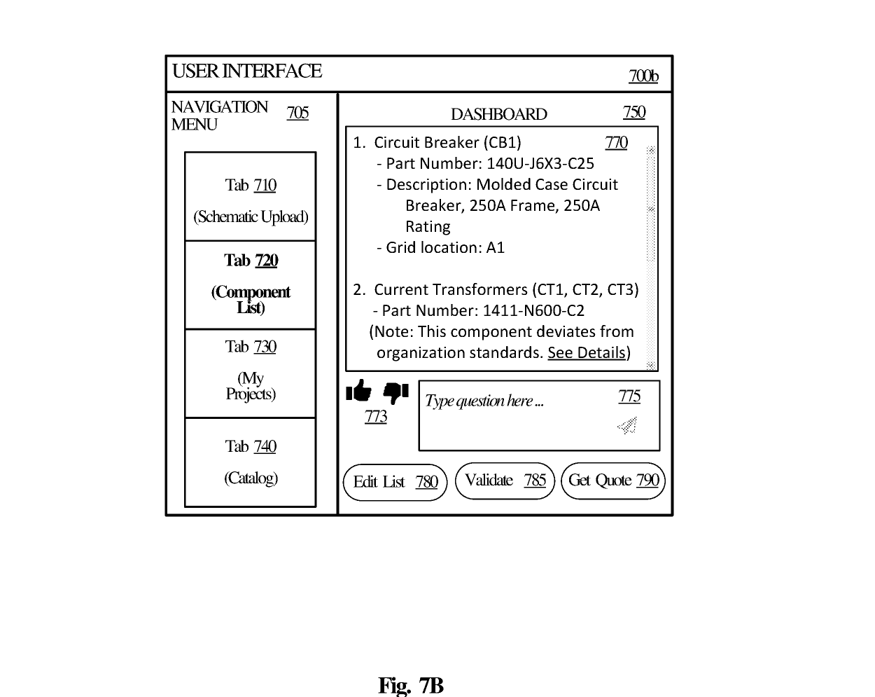

User device 120 is a device utilized by users in industrial automation environment 100 to obtain industrial assistance. User device 120 may be a cell phone, tablet, laptop, human interface module (HIM), personal computer, or any other device capable of interfacing with industrial resource service 110. User device 120 may be represented by computing system 801 in FIG. 8. While one user device 120 is shown in FIG. 1 for simplicity, industrial automation environment 100 may include many user devices 120, with multiple users interacting with industrial resource service 110. User device 120 may interface with industrial resource service 110 via a web-browser or an application running on user device 120. A user on user device 120 may use a user interface on user device 120 to submit schematics to industrial resource service 110 and view lists of part numbers provided by industrial resource service 110, as shown in FIGS. 7A and 7B in an implementation.

Model collection 150 is representative of a collection of GAI models 140a, 140n (collectively, GAI models 140) leveraged by industrial resource service 110. While two GAI models 140 are illustrated for simplicity, model collection may include more GAI models 140 in some implementations. It is noted that in some implementations, industrial resource service 110 may utilize only one GAI model 140.

GAI models 140 may be trained on industrial documentation provided by industrial resource service 110. The training is directed to providing GAI models 140 with the ability to competently interpret industrial schematics and select appropriate part numbers for the visual elements in schematics. The industrial documentation provided to GAI models 140 may include historical industrial project data including schematics and associated part-number lists, industrial standards, industrial laws and regulations, industrial product specifications, among other types of documentation. It is noted that while some schematic formats (such as P&ID) utilize standard icons for components, a particular industrial manufacturer may utilize its own unique symbols. The training of GAI models 140 may include schematics with both the standardized symbols and manufacturer-specific symbols, facilitating the selection of manufacturer-specific components for customers. The training thus provides for intelligent data extraction, providing GAI model 140 with the ability to identify both standardized symbols and manufacturer-specific symbols.

The utilization of multiple GAI models 140 allows for the training to be tailored to specific applications across various environments. Each GAI model 140 may be directed to one or more specific industries (e.g., food and beverage) and locations (e.g., United States). Accordingly, the training process may be tailored based on the specialty of the specific GAI model 140. For example, for a GAI model 140 directed to the food and beverage industry in the United States, documentation provided in the training process may include industry standards for the food and beverage industry, and United States laws and regulations. Industrial resource service 110 may select GAI model 140 based on the relevant industry and location, as described in greater detail below in the discussion of model selection module 235 of FIG. 2.

Generative artificial intelligence (GAI) models (also sometimes known as foundation models) are models trained to generate new data based on a training dataset. GAI models, as used herein, include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Multimodal models are a class of GAI model that accepts multimodal data including text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of a given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

FIG. 2 illustrates a detailed view of industrial resource service 110. Industrial resource service 110 includes user interface (U/I) module 210, segment creation module 215, list generation module 220, validation module 225, GAI interface module 230, model selection module 235, training module 240, user data repository 245, and product catalog 250. While these modules and elements are depicted to describe the list generation and validation workflows described herein, the functionalities described may be incorporated into more or fewer components, software components, hardware components, firmware components, or a combination without departing from the scope and spirit of the present disclosure.

U/I module 210 is a module configured to interface with user device 120. U/I module 210 receives user-submitted queries (e.g., requests for creating or validating a list of parts based on a schematic) from user device 120 and provides responses to user device 120. U/I module 210 may also perform various other user interface functions, including receiving feedback from users and managing user authentication and continuity.

List generation module 220 is representative of a module configured to facilitate the generation of a list of part numbers based on a schematic (where the schematic may be obtained from user device 120 via U/I module 210). To identify the part numbers, list generation module 220 first leverages GAI model 140 (which may be selected by model selection module 235 as discussed below) to identify specific physical components corresponding to the visual elements in the schematic. In particular, list generation module 220 generates one or more resource prompts tasking GAI model 140 with identifying specific physical components corresponding to the visual elements. For example, where a schematic includes an icon of a pump and functional specifications for the pump (e.g., voltage and flow rate), GAI model 140 returns, in response to the prompt, a textual identification of the element and its functional specification. The output from the list generation module 220 may be a complete list of part numbers (i.e., bill of materials) that identifies each component, quantity, and specifications to build a complete industrial automation system design based on the submitted schematic.

In some implementations, list generation module 220 generates multiple resource prompts for a single schematic, with each prompt focusing on a specific segment (e.g., grid segment) of the schematic. This segmentation process is supported by segment creation module 215, as discussed below. By dividing the schematic into smaller segments and feeding these segments to GAI model 140 individually, the process improves identification accuracy, as the accuracy of GAI model 140 may decrease when processing large and complex schematics in a single input. GAI Interface module 230 submits these resource prompts to GAI model 140 and obtains identifications of specific physical components (e.g., “circuit breaker” or “pump”).

Upon obtaining the identifications of specific physical components (generated by GAI model 140 in response to the resource prompts), list generation module 220 maps these components to corresponding part numbers. This mapping process involves matching the identified components to entries in a predefined database or catalog of part numbers provided by industrial resource service 110.

In some implementations, the mapping process may include generating a consolidated prompt for GAI model 140. This consolidated prompt includes the specific physical components identified from each segment (e.g., grid segment) as well as the entire schematic diagram. By including the complete schematic, GAI model 140 can analyze the relationships and dependencies between the physical components identified in the individual segments. GAI interface module 230 submits the consolidated prompt to GAI model 140 and obtains the list of part numbers generated by GAI model 140. These part numbers identify components in product catalog 250 available for purchase. Industrial resource service 110 thus translates the abstract representation of a system into a list of part numbers that may be purchased to build the system. Once the list is obtained, list generation module 220 may format the list for user readability. For example, the list may be grouped by component type, cost, or functional role within the system, providing an organized and actionable output for the user. U/I module 210 transmits the list to user device 120 for display, as shown for example in user interface 700b of FIG. 7B.

Segment creation module 215 is configured to divide the obtained schematic into smaller, manageable segments, as illustrated by element 760 in FIG. 7. These segments are used by list generation module 220 during prompt generation to facilitate the identification of specific physical components as discussed above. In some implementations, the segment creation process is automated using software procedures that identify visual elements, such as icons, and arrange the grid to minimize segmentation of individual elements. In other words, the overlay (e.g., grid) that segments the schematic should be arranged to avoid a segmenting line running directly through an element, when possible. In other implementations, a user or administrator may manually configure the grid (e.g., via a user interface of user device 120). This provides that each component remains intact within a segment, preventing errors in identification. Additionally, segment creation module 215 may divide the schematic into overlapping segments to guarantee that each visual element is fully captured in at least one segment. This overlap reduces the risk of incomplete inputs being processed by GAI model 140, thereby improving overall identification accuracy.

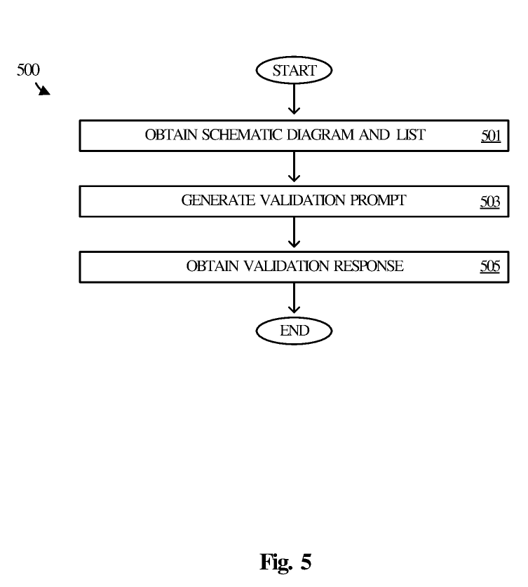

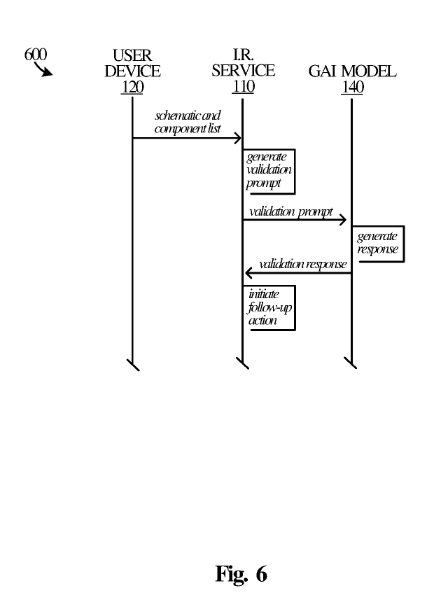

Validation module 225 is representative of a module configured to validate a list of part numbers against a schematic. Validation module 225 may be configured to provide anomaly detection and bi-directional validation by identifying potential issues in a list of part numbers. For example, potential issues may include a visual element in a schematic not having a corresponding part number in the list of part numbers, or a part number in a list not corresponding to a visual element in the schematic. Validation module 225 may also be configured to check for regulatory compliance (checking the list of part numbers against industry standards and regulatory requirements) and standards matching (ensuring that the list of part numbers meets industry standards such as IEC and NEC). This validation may be performed by submitting validation prompts to GAI models 140. Validation module 225 may validate a list generated by list generation module 220, or a list submitted by user device 120 (e.g., where a customer creates both a schematic and a list of part numbers) in various scenarios. The processes performed by validation module 225 are discussed in greater detail in relation to FIGS. 5 and 6 below.

GAI interface module 230 is a module configured to interface with generative artificial intelligence models 140. Generative artificial intelligence (GAI) interface module 230 performs preprocessing on prompts generated by other modules, such as list generation module 220 and validation module 225, and validation module 225, as discussed above. After preprocessing, generative artificial intelligence interface module 230 submits the refined prompts to generative artificial intelligence model 140 for processing. Once generative artificial intelligence model 140 generates responses, GAI interface module 230 receives these responses and conducts an initial validation, which includes checking for syntax errors and ensuring the responses meet basic correctness criteria before passing them along for further operations.

Model selection module 235 is a model configured to select a GAI model 140 from model collection 150 for the list generation and validation workflows processes above. Model selection module 235 may select a GAI model 140 based on one or both of a location and a relevant industry of the industrial system associated with a schematic. In particular each GAI model 140 in model collection may be uniquely trained to one or more specific locations and industries. Thus, where generation of a list of part numbers or validation of a list of part numbers is requested (e.g., by user device 120) model selection module 235 selects a GAI model 140 for the generation or validation based on one or both of the industry and location of the industrial system represented in the schematic. The location and industry may be obtained from metadata associated with the schematic in some implementations. GAI interface module 230 routes various prompts from list generation module 220 and validation module 225 to the selected GAI model 140.

Training module 240 is configured to train and update GAI models 140 in model collection 150 (see FIG. 1). This training fine-tunes GAI models 140 to perform industrial tasks (e.g., generation or validation of part-number lists). The initial training may be an unsupervised learning process, including providing the base model with static data including historical projects, industrial product literature, industry standards (e.g., IEC standards and NEC standards among others), data about industrial standards (e.g., standard configurations for industrial units such as motor control centers (MCCs)), among other documentation. As part of this process, GAI models 140 are trained to recognize standard industrial symbols and their corresponding textual descriptions. For example, GAI models 140 may be trained to associate an icon of a submersible pump with the text description “submersible pump.” GAI models 140 may also be trained to recognize company-specific symbols for components. For instance, an industrial manufacturer or organization may use proprietary symbols that are not widely adopted in industry standards. Training on these company-specific symbols provides that GAI model 140 can accurately interpret and process schematics and documentation specific to a given organization, thus providing for intelligent data extraction.

Each GAI model 140 may also be specifically trained using documentation tailored to its designated industries and/or geographic locations. This training may include incorporating industry-specific standards, such as requirements for components in the food and beverage industry to be wash-down safe, or standards for pharmaceutical cleanrooms. Additionally, training may include location-specific industrial regulations to provide compliance with regional codes and safety requirements. As a result, the model collection 150 includes GAI models 140 that are uniquely fine-tuned for specific applications, industries, or geographic contexts. These specialized models can then be selected by model selection module 235, as described above, to provide tailored performance for a given task or project.

Training module 240 may be configured to train GAI model 140 to recognize and interpret symbols based on their contextual placement within a schematic, as a supplement to the recognition based on standardized icons or labeling; thus providing for contextual understanding and interpretation. By supplying GAI model 140 with documentation (e.g., historical schematics) that demonstrates each symbol’s functional relationship to surrounding elements, training module 240 provides that GAI model 140 can accurately parse schematics created in different software environments or with unique symbolism. Training module 240 thus equips GAI model 140 to identify components even when non-standard or proprietary symbols are used, thereby supporting robust data extraction from a wide variety of industrial schematics.

Training module 240 is also configured to train GAI model 140 on product lifecycle information and up-to-date product catalog data (e.g., documentation for newly released products). By leveraging this training, GAI model 140 can suggest the latest or preferred product portfolio options when generating the list of part numbers. By recommending actively supported products and identifying phase-out items, GAI model 140 provides that users obtain current and reliable components for their industrial systems when generating part-number lists.

Training module 240 also leverages historical data by accessing historical projects and schematics stored in user data repository 245 and training GAI model 140 on these documents (data archiving and mining). This enhances the predictive capabilities of GAI model 140, providing it with the ability to perform trend analysis identifying recurring component usage patterns, and preferred configurations for a given user across multiple projects. This training provides that lists generated by GAI model 140 align with each customer’s established purchasing and design preferences (learned customer ordering habits). Through this comprehensive use of historical data, the GAI model continuously adapts to evolving industrial practices and customer requirements, resulting in more accurate and tailored part-number lists.

Training module 240 facilitates continuous training and fine-tuning of GAI models 140 through adaptive learning and a user feedback loop. Training module 240 provides feedback to GAI models 140 including user-submitted responses to generated part-number lists and validation outputs. For example, users may provide feedback via element 773 of user interface 700b in FIG. 7B. This user feedback provides for more accurate and reliable outputs over time.

Adaptive learning enables GAI models 140 to improve their symbol and pattern recognition capabilities as they process user-submitted schematics. Over time, this learning allows the models to better identify and interpret complex industrial symbols, configurations, and relationships, even in scenarios where variations or non-standard symbols (e.g., manufacturer-specific symbols) are present. By continuously updating their knowledge base, the models become increasingly precise and efficient in generating and validating part-number lists.

The user feedback loop incorporates feedback from user interactions within industrial resource service 110, including user selections, modifications, finalized part-number lists and user feedback responses (e.g., likes and dislikes). By leveraging both adaptive learning and the user feedback loop, training module 240 provides that GAI models 140 remain up to date with changing industry preferences, regulations, and technological advancements. This continuous improvement cycle not only enhances the accuracy and relevance of the models but also provides that they stay aligned with the specific preferences of various industries and regions.

User data repository 245 is representative of a repository storing customer-specific data associated with various users, including a user of user device 120 (as shown in FIG. 1). This may include historical project documentation such as historically submitted schematics and part-number lists, company-specific standards (which may be included in prompts for GAI models as additional context), among other types of user information.

Product catalog 250 is representative of a catalog of industrial parts that may be produced or offered for sale by an industrial manufacturer (e.g., Rockwell Automation). Industrial parts in product catalog may include associated part numbers used to build part-number lists for building industrial systems, as described herein.

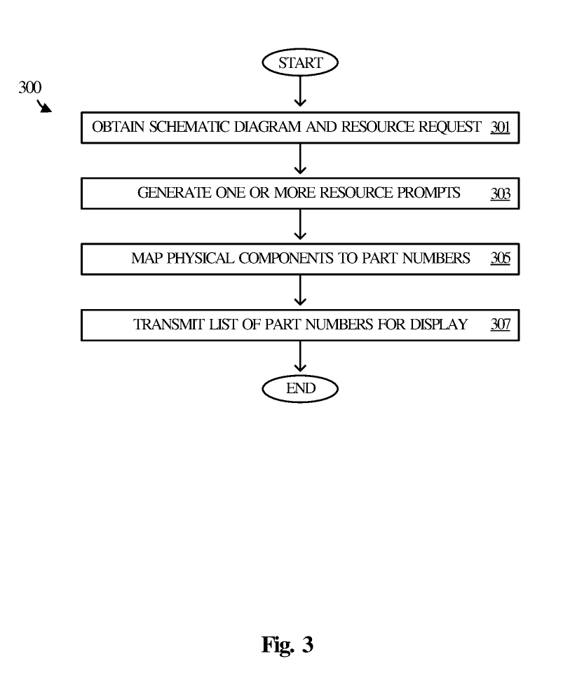

FIG. 3 illustrates a part-number list generation process performed by industrial resource service 110, represented by process 300. Process 300 is employed by a computing device, an example of which is provided by computing system 801 of FIG. 8. Process 300 may be implemented in program instructions (software and/or firmware) by one or more processors of the computing device. The program instructions direct the computing device to operate as follows, referring to the steps in FIG. 3.

Step 301 is obtaining a schematic diagram of an industrial system and a resource request to generate a list of part numbers based on the schematic. Step 301 is performed by industrial resource service 110, and more specifically by U/I module 210 of FIG. 2. The schematic diagram may be uploaded by a user via a user device, for example, utilizing element 751 of user interface 700a in FIG. 7A. The user may submit the resource request via the user interface, for example, by selecting element 755 of FIG. 7A. In some implementations, the user may upload customer-specific standards with the request, as illustrated in element 753 of FIG. 7A. It is noted that GAI models 140 may not be trained on customer-specific information (e.g., a specific organization may have higher safety standards than those required by local regulations). Uploading the customer-specific standards allows the industrial resource service 110 to include these in prompts for GAI model 140 as contextual information for generating the list of parts.

Step 303 is generating one or more resource prompts. Step 303 is performed by industrial resource service 110, and more specifically by list generation module 220 of FIG. 2. The one or more resource prompts task the GAI model with identifying specific physical components corresponding to the visual elements in the schematic diagram. In some implementations, multiple resource prompts are generated, where each of the resource prompts includes segments (as illustrated in element 760 of FIG. 7A) of the schematic. These segments may be created by segment creation module 215, as described above in the discussion of FIG. 2. In other implementations, one resource prompt including the entire schematic diagram is generated in step 303.

The one or more resource prompts are submitted to GAI model 140. GAI model 140 visually parses the schematic (or segment of the schematic) to generate a textual identification of the specific physical components and their functional specifications (e.g., a “submersible pump operating at 480 Volts”). These textual descriptions are subsequently used to generate a list of part numbers, as described below.

Step 305 is mapping the identified specific physical components (which are generic terms for components such as “circuit breaker”) to part numbers (which identify specific models of components, that may be purchasable for example in a product catalog) to create a list of part numbers. Step 305 is performed by industrial resource service 110, and in particular by list generation module 220. In some implementations, this mapping process includes generating a consolidated prompt designed to elicit a response from GAI model 140. The consolidated prompt instructs GAI model 140 to generate the list of parts based, at least in part, on a correlation between the specific physical components identified in step 303 and the entire schematic diagram. The consolidated prompt may also include the customer-specific standards obtained in step 301.

The consolidated prompt may include the textual identification of the specific physical components as well as the corresponding segment for each visual element. By incorporating the entire schematic diagram into the consolidated prompt, GAI model 140 may analyze relationships between the identified physical components, to achieve contextual understanding and interpretation. For example, the model may determine that a pump is located upstream of a valve and that the valve should be rated to handle the flow and pressure produced by the pump. Analyzing these relationships provides for compatibility and performance within the industrial system. GAI model 140 may also leverage its training on product lifecycles to suggest recently released or preferred products in the generated list of part numbers and may further leverage its training on historical projects to generate a list of part numbers aligning with customer trends and ordering habits.

In addition to considering functional and relational aspects of the components, GAI model 140 leverages its training on industry standards (e.g., IEC, NEC) and utilizes the customer-specific standards contained in the consolidated prompt to perform standards matching. By doing so, GAI model 140 provides that all selected components and their configurations not only meet the schematic’s operational criteria but also comply with the relevant industry guidelines and any heightened standards set forth by the customer. For instance, if a customer’s standards specify an enclosure type for a motor controller, GAI model 140 will attempt to find a part that fully meets this standard in addition to the operational requirements from the schematic. If no such part exists, GAI model 140 may choose the closest compliant alternative, noting a deviation from the requested specification. For example, rather than selecting an enclosure rated IP68 as requested, it may select a part rated IP66 if that is the highest available rating that still meets operational and regulatory needs. Industrial resource service 110 may provide an indication of this deviation to user device 120 (as illustrated in element 770 of user interface 700b of FIG. 7B). GAI model 140 further leverages its training to provide regulatory compliance (i.e., ensuring the list of part numbers complies with local regulations).

Industrial resource service 110 may also use other techniques to perform the mapping in various implementations. For example, industrial resource service 110 could cross-reference the identified components with a ranked list of parts stored in product catalog 250. Industrial resource service 110 could then match each component to the highest-ranked part that aligns with both the schematic’s parameters and the customer-specific standards. In this scenario, if the top-ranked option is unavailable or noncompliant, the model systematically evaluates lower-ranked options until a suitable match is found, again noting any deviations for the user’s review.

Step 307 is transmitting the list of part numbers to user device 120 for display. Step 307 may be performed by industrial resource service 110, and more particularly by U/I module 210. In addition to transmitting the part-number list itself, industrial resource service 110 may also transmit instructions to display a correlation between each part number in the list and its associated visual element in the schematic. For example, as shown in user interface 700b of FIG. 7B, a circuit breaker identified in the list might be correlated with segment “A1” of the schematic. Similarly, if the schematic includes a pump in segment B2 and sensors in segment C3, each respective part number can be presented in a way that clearly indicates its corresponding segment. By providing this correlation information, the user on user device 120 can more easily navigate the schematic and quickly identify which part number is associated with each visual element. Upon receiving this correlated list of part numbers, the user may take various actions such as submitting a request for a quote for purchasing the identified parts, for example by selecting element 790 of FIG. 7B.

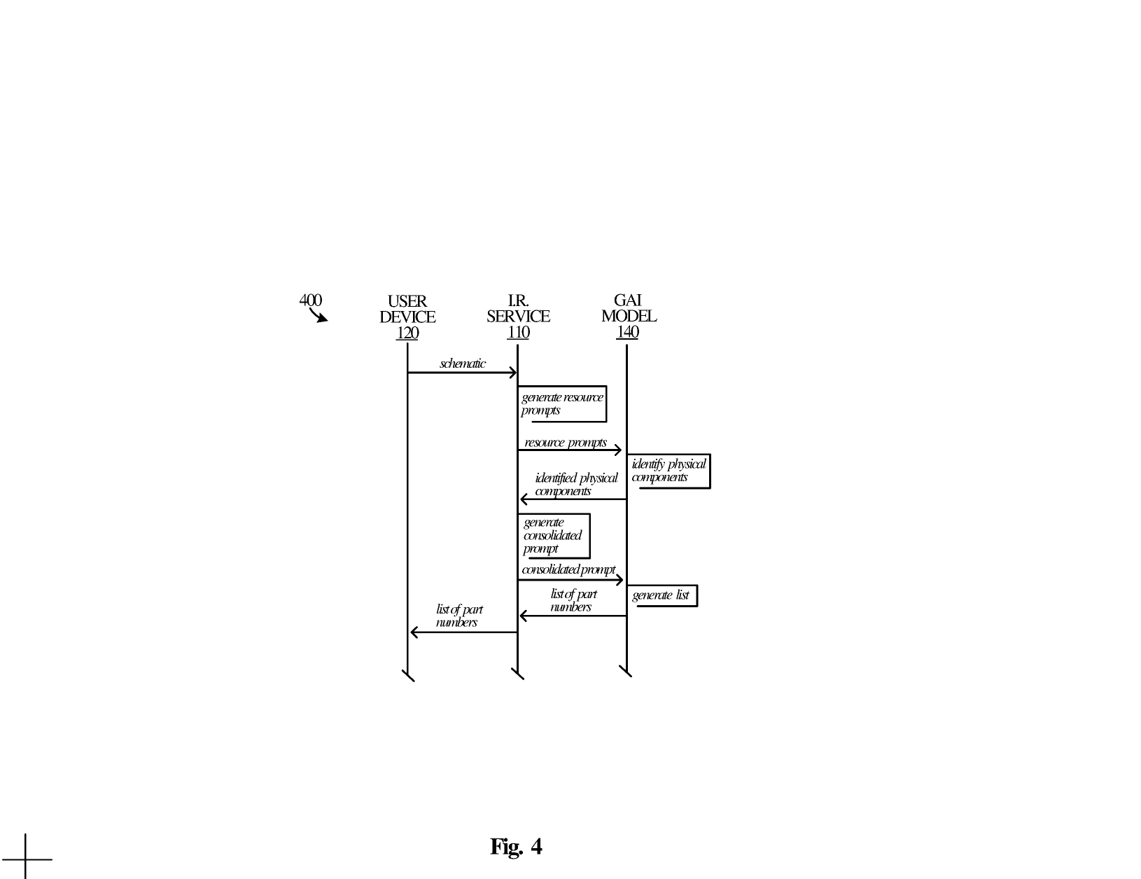

FIG. 4 illustrates an operational sequence of an application of process 300 in the context of industrial automation environment 100 in an implementation, represented by sequence 400. Sequence 400 includes user device 120, industrial resource service 110, and GAI model 140.

In sequence 400, user device 120 submits a schematic to industrial resource service, as described above with respect to step 301 of process 300. Industrial resource service 110 generates one or more resource prompts, as described above with respect to step 303 of process 300. Industrial resource service 110 submits the resource prompts to GAI model 140. GAI model 140 generates a response for each of the resource prompts by leveraging its training on large datasets of industrial schematics, components, and specifications. GAI model 140 identifies specific physical components within the schematic and the described functional requirements, such as voltage or flow rate. GAI model 140 responds to industrial resource service 110 with the identified physical components including textual descriptions of the components and their corresponding attributes.

Industrial resource service 110 then generates a consolidated prompt tasking GAI model 140 with identifying part numbers corresponding to the identified physical components, as discussed above in relation to step 305 of process 300. Industrial resource service 110 submits the consolidated prompt to GAI model 140. GAI model 140 generates the list of part numbers and provides it to industrial resource service 110. Industrial resource service transmits the list of part numbers to user device 120 for display, as discussed above in relation to step 307 of process 300.

FIG. 5 illustrates a part-number list generation process performed by industrial resource service 110, represented by process 500. Process 500 is employed by a computing device, an example of which is provided by computing system 801 of FIG. 8. Process 500 may be implemented in program instructions (software and/or firmware) by one or more processors of the computing device. The program instructions direct the computing device to operate as follows, referring to the steps in FIG. 3.

Step 501 is obtaining a schematic diagram and a part-number list. In one scenario, the schematic diagram is the schematic diagram of process 300, while the part-number list is the part number list generated by process 300. In this scenario, process 500 is performed to validate the list generated in process 300. This may be performed automatically as an additional check before providing the list to user device 120 (e.g., after step 305 but before step 307 of process 300) in some scenarios, thus providing for bi-directional validation of the list of part numbers. In other scenarios, the validation of process 500 is performed in response to a user selection, such as a selection of element 785 of FIG. 7B. In other scenarios, a user may submit a schematic along with a part-number list with a request to validate the part-number list. This may occur, for example, where a customer creates a list of part numbers manually or otherwise separately from industrial resource service 110.

Step 503 is generating a validation prompt for GAI model 140. Step 503 is performed by industrial resource service 110, and more specifically by validation module 225 of FIG. 2. The validation prompt tasks the GAI model with validating the list of part numbers by cross-referencing the list of part numbers with the schematic diagram. The validation prompt may include instructions to check for various issues, such as a visual element in the schematic not having a corresponding part number in the list, a part number in the list not having a corresponding visual element in the schematic, a part number being a suboptimal or inappropriate selection, a part number failing to meet industrial standards, and a part number failing to meet regulatory requirements, among other issues.

Step 505 is obtaining a validation response from GAI model 140. The validation response may either confirm accuracy of the list of part numbers or may identify a potential issue with respect to the list of part numbers. This validation response is generated by GAI model 140 in response to the validation prompt. GAI model 140 leverages its training to perform regulatory compliance checks (checking the list of part numbers against regulatory requirements) and standards matching (ensuring that the list of part numbers meets industry specific standards such as IEC and NEC). GAI model 140 also performs anomaly detection to identify inconsistencies (e.g., checking that each visual element in the schematic has a corresponding part number in the list, and that each part number in the list has a corresponding visual element in the schematic). Where the validation response confirms accuracy, industrial resource service 110 may transmit a confirmation of the accuracy to user device 120 for display. Industrial resource service 110 provides the list of part numbers to user device 120 for display in response to the confirmation (where the validation is used as an additional check before providing the list to the user). Where GAI model 140 identifies a potential issue (e.g., a visual element not having a corresponding part number in the list), industrial resource service 110 may automatically initiate corrective action. This corrective action may include providing an alert to user device for display, initiating the generation of a new list based on the schematic (for example as described in process 300), suggesting a correction (e.g., prompting the user to add a part number to the list) automatically making a correction (e.g., automatically adding the part number to the list), among other potential actions.

FIG. 6 illustrates an operational sequence of an application of process 500 in the context of industrial automation environment 100 in an implementation, represented by sequence 600. Sequence 600 includes user device 120, industrial resource service 110, and GAI model 140.

In sequence 600, user device 120 provides a schematic and list of part numbers to industrial resource service 110 (however, it is noted that in some scenarios the part-number list may be one generated by process 300). Industrial resource service 110 generates validation prompts, as described above in relation to step 503 of process 500. Industrial resource service submits the validation prompt to GAI model 140. GAI model 140 generates a response and provides it to industrial resource service. This response may either be a confirmation of the part-number list or identify a potential issue as described above in relation to step 505 of process 500. Industrial resource service 110 initiates a follow-up action, which may differ depending on whether the validation response is a confirmation or identifies a potential issue, as described above in relation to step 505 of process 500.

FIGS. 7A and 7B illustrate user interfaces 700a, 700b of user device 120 according to some implementations. User interfaces 700a, 700b, illustrate user interfaces displayed to a user requesting part-list generation and validation. It is noted that user interfaces 700a and 700b illustrate some examples; in other implementations user interfaces on user device 120 may have different arrangements, different elements, or additional or fewer elements.

FIG. 7A illustrates user interface 700a in an implementation. User interface 700a includes navigation menu 705 and dashboard 750. Navigation menu 705 includes tabs 710, 720, 730, 740. Tab 710 is selectable to illustrate a screen where a user may upload a schematic, as illustrated in FIG. 7A. Tab 720 is selectable by a user for viewing a list of part numbers associated with the schematic, as described further in relation to FIG. 7B. Tab 730 is selectable to view historical projects, which may be stored, for example, in user data repository 245 of industrial resources service 110. Tab 740 is selectable to view a product catalog, which is represented by product catalog 250 of FIG. 2.

Dashboard 750 of user interface 700a is displayed on selection of tab 710. Element 751 illustrates an element by which a user may upload a file of schematic, where the schematic is illustrated in element 752. Element 753 represents an element where a user may upload organization-specific or customer-specific standards, as discussed above in relation to step 301 of process 300. Element 755 represents an element a user may select to request a list of part numbers based on the schematic (e.g., to initiate process 300 as discussed above). Element 760 illustrates a grid overlay of the schematic displayed to the user. This grid overlay may be used to generate multiple resource prompts for GAI model, where each resource prompt includes a grid segment (e.g., the segment “A1,” “C2,” etc.), as discussed above in relation to segment creation module 215.

FIG. 7B illustrates user interface 700b in an implementation, displayed when a user selects tab 720 to view a list of part numbers generated for the schematic (e.g., by process 300). User interface 700b includes navigation menu 705 and dashboard 750, similar to user interface 700a. In this implementation, dashboard 750 displays element 770, which presents the identified specific physical components (e.g., “Circuit Breaker 1”) and their associated part numbers (e.g., “140U-J6X3-C25”). Each entry in the part-number list may include an identified physical component, a part number, a brief description of the component’s specifications, and a corresponding grid location within the schematic (e.g., segment A1, as derived from element 760 in FIG. 7A). This grid location provides a correlation between each part number in the list of part numbers and its associated visual element in the schematic, as discussed above with respect to step 307 of process 300. Some components may include additional notes, for example indicating deviations from an organization’s standards (such as the customer-specific standards uploaded by the user in element 753 of FIG. 7A, and as described above in the discussion of step 305 of process 300).

User interface 700b also includes other interactive elements. Element 773 allows the user to provide feedback (e.g., like or dislike) on the generated list, supporting a feedback loop to improve the accuracy of future recommendations, as described above in relation to training module 240. Element 775 is a user input field where a user may type a question related to the displayed components, for example to initiate a conversation with a chatbot provided by industrial resource service 110 and leveraging GAI models 140. Additional interface elements at the bottom of the dashboard include an “Edit List” element 780 to modify the current list of part numbers, a “Validate” element 785 to request validation of the listed components against the schematic (which may initiate process 500 according to some implementations), and a “Get Quote” element 790 for initiating a purchase process based on the displayed part numbers.

FIG. 8 illustrates computing system 801 that is representative of any system or collection of systems in which the various processes, programs, services, and scenarios disclosed herein may be implemented. Examples of computing system 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements industrial resource processes 806, which is (are) representative of the application service processes discussed with respect to the preceding figures, such as process 300 of FIG. 3 and process 500 of FIG. 5. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may comprise a microprocessor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer-readable storage media device readable by processing system 802 and capable of storing software 805. Storage system 803 may include volatile and nonvolatile, removable, and non-removable media implemented in any method or technology for storage of information, such as computer readable software instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated or transitory signal.

In addition to computer-readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including industrial resource processes 806) may be implemented in program instructions and among other functions may, when executed by processing system 802, direct processing system 802 to operate as described with respect to the various operational scenarios, sequences, and processes illustrated herein. For example, software 805 may include program instructions for implementing industrial resource processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system customized to support an application service in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples of the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for generating industrial part number lists, comprising:
obtaining, from a user device, a schematic diagram of an industrial system and a resource request for a list of part numbers to build the industrial system, wherein the schematic diagram illustrates visual elements representing physical components in the industrial system and their associated functional specifications;
generating one or more resource prompts designed to elicit a response from a generative artificial intelligence (GAI model), wherein the one or more resource prompts task the GAI model with identifying specific physical components corresponding to the visual elements in at least a portion of the schematic diagram, wherein each of the one or more resource prompts includes at least a portion of the schematic diagram;
mapping the identified specific physical components to part numbers to generate the list of part numbers; and
transmitting the list of part numbers to the user device for display.

2. The computer-implemented method of claim 1, further comprising:
dividing the schematic diagram into a plurality of segments, wherein:
the one or more resource prompts comprises a plurality of resource prompts, and
the at least the portion of the schematic diagram for each of the plurality of resource prompts corresponds to one of the plurality of segments.

3. The computer-implemented method of claim 2, wherein the mapping the identified specific physical components comprises:
generating a consolidated prompt designed to elicit a response from the GAI model, wherein the consolidated prompt tasks the GAI model with generating the list of parts based at least in part on a correlation between the identified specific physical components and the entire schematic diagram.

4. The computer-implemented method of claim 3, wherein:
the consolidated prompt further comprises customer-specific standards and tasks the GAI model with generating the list of part numbers based additionally on the customer-specific standards; and
the method further comprises transmitting an identification of a deviation from the customer-specific standards to the user device for display.

5. The computer-implemented method of claim 1, further comprising:
generating a validation prompt designed to elicit a second response from the GAI model, wherein the validation prompt tasks the GAI model with validating the list of part numbers by cross-referencing the list of part numbers with the schematic diagram; and
obtaining a validation response from the GAI model.

6. The computer-implemented method of claim 5, wherein the validation response is a confirmation of accuracy for the list of resources, and wherein the method further comprises:
transmitting an indication of the confirmation to the user device for display.

7. The computer-implemented method of claim 5, wherein the validation response includes an identification of a potential issue with respect to the list of components, and wherein the method further comprises:
initiating a corrective action to address the potential issue.

8. The computer-implemented method of claim 1 further comprising:
selecting the GAI model from a plurality of GAI models based on one or both of: an industry associated with a user submitting the resource request and a location of the user.

9. The computer-implemented method of claim 1, further comprising,
transmitting, with the list of part numbers and to the user device, instructions to display a correlation between each part number in the list of part numbers and its associated visual element in the schematic diagram.

10. The computer-implemented method of claim 1, wherein the GAI model is trained on industrial documentation comprising one or more of: historical industrial project data, industrial standards, and industrial product specifications.

11. A system comprising:
one or more processors; and
one or more memories operably coupled to the one or more processors and having stored thereon software instructions that, upon execution by the one or more processors, cause the one or more processors to:
obtain, from a user device, a schematic diagram of an industrial system and a resource request for a list of part numbers to build the industrial system, wherein the schematic diagram illustrates visual elements representing physical components in the industrial system and their associated functional specifications;
generate one or more resource prompts designed to elicit a response from a generative artificial intelligence (GAI model), wherein the one or more resource prompts task the GAI model with identifying specific physical components corresponding to the visual elements in at least a portion of the schematic diagram, wherein each of the one or more resource prompts includes at least a portion of the schematic diagram;
map the identified specific physical components to part numbers to generate the list of part numbers; and
transmit the list of part numbers to the user device for display.

12. The system of claim 11, wherein the software instructions comprise further instructions that, upon execution by the one or more processors, cause the one or more processors to:
divide the schematic diagram into a plurality of segments, wherein:
the one or more resource prompts comprises a plurality of resource prompts, and
the at least the portion of the schematic diagram for each of the plurality of resource prompts corresponds to one of the plurality of segments.

13. The system of claim 12, wherein the mapping the identified specific physical components comprises:
generating a consolidated prompt designed to elicit a response from the GAI model, wherein the consolidated prompt tasks the GAI model with generating the list of parts based at least in part on a correlation between the identified specific physical components and the entire schematic diagram.

14. The system of claim 13, wherein:
the consolidated prompt further comprises customer-specific standards and tasks the GAI model with generating the list of part numbers based additionally on the customer-specific standards.

15. The system of claim 11, wherein the software instructions comprise further instructions that, upon execution by the one or more processors, cause the one or more processors to:
generate a validation prompt designed to elicit a second response from the GAI model, wherein the validation prompt tasks the GAI model with validating the list of part numbers by cross-referencing the list of part numbers with the schematic diagram; and
obtain a validation response from the GAI model.

16. The system of claim 15, wherein the validation response is a confirmation of accuracy for the list of resources, and wherein the software instructions comprise further instructions that, upon execution by the one or more processors, cause the one or more processors to:
transmit an indication of the confirmation to the user device for display.

17. The system of claim 15, wherein the validation response includes an identification of a potential issue with respect to the list of components, and wherein the software instructions comprise further instructions that, upon execution by the one or more processors, cause the one or more processors to:
initiate a corrective action to address the potential issue.

18. The system of claim 11, wherein the software instructions comprise further instructions that, upon execution by the one or more processors, cause the one or more processors to:
select the GAI model from a plurality of GAI models based on one or both of: an industry associated with a user submitting the resource request and a location of the user.

19. The system of claim 11, wherein the software instructions comprise further instructions that, upon execution by the one or more processors, cause the one or more processors to:
transmit, with the list of part numbers and to the user device, instructions to display a correlation between each part number in the list of part numbers and its associated visual element in the schematic diagram.

20. The system of claim 11, wherein the GAI model is trained on industrial documentation comprising one or more of: historical industrial project data, industrial standards, and industrial product specifications.
